(19) United States
(12) Patent Application Publication
(10) Pub. No.: US 2026/0142874 A1
(43) Pub. Date: May 21, 2026

(54) ESTABLISHMENT OF AN INTERFACE BETWEEN UNITS IN A RADIO ACCESS NETWORK

(71) Applicant: TELEFONAKTIEBOLAGET LM ERICSSON (PUBL), Stockholm (SE)

(72) Inventors: Stefano STRACCA, Pisa (IT); Rikard THID, Tyresö (SE); Paolo DEBENEDETTI, Genova (IT)

(21) Appl. No.: 18/705,919

(22) PCT Filed: Oct. 29, 2021
(86) PCT No.: PCT/EP2021/080225

§ 371 Date: Apr. 29, 2024

(51) Int. Cl. H04L 69/18; H04L 41/0803

(52) U.S. Cl. CPC H04L 41/0803

(57) ABSTRACT

According to an aspect there is provided a method of operating a first unit in a radio access network (RAN) to configure a first interface with a second unit in the RAN. The first unit is capable of using one or more RAN protocol stacks for the first interface to the second unit. The method includes receiving a first notification from the second unit, the first notification indicating one or more RAN protocol stack capabilities of the second unit for use over the first interface to the first unit; determining a RAN protocol stack to use for the first interface according to the one or more RAN protocol stack capabilities of the first unit and the one or more RAN protocol stack capabilities of the second unit; and configuring the first interface with the second unit according to the determined RAN protocol stack.

### TECHNICAL FIELD

This disclosure relates to the establishment of an interface between units in a radio access network (RAN).

### BACKGROUND

The Common Public Radio Interface (CPRI) defines an internal interface in radio base stations between a Radio Equipment Control (REC) and Radio Equipment (RE). The REC is also known as a baseband unit (BBU)—also shortened herein to ‘basebands’ (BB)—and the RE is also known as a remote radio head (RRH)—also shortened herein to ‘radios’. This internal interface is known as a ‘fronthaul’ interface.

Enhanced CPRI (eCPRI) is a RAN protocol stack for the transfer of user plane information between REC and RE via a packet-based fronthaul transport network. In eCPRI, and in particular the eCPRI 2.0 standard, installation and operation of RAN networks becomes more flexible, but also more complex to manage, since they can combine different entities with different capabilities. For example, the entities can include radios (RRUs) implementing eCPRI (Lower Layer Split (LLS)), mainly in the low and mid-band; while high band typically use analog beamforming (ABF) where CPRI interface is commonly used. In addition, there can be basebands (BBUs) supporting different capabilities. For example, a ‘new generation’ BB supporting both CPRI and eCPRI in the same unit; new Cloud RAN sites (COTS) supporting only Ethernet and eCPRI interfaces; a BB supporting only one of CPRI and eCPRI for the same unit (configurable); and a legacy BB supporting only CPRI.

In order to secure efficient management of the RAN network, including new specifications for Cloud RAN, it is very important to automate the connection between the split functions and avoid any restart of the radio (RRH) due to the transition between different protocols.

### SUMMARY

An aim is to provide a zero-touch-fronthaul provisioning (ZTFP) network where all the elements of the RAN network can easily identify themselves and then negotiate their supported protocols. Such an approach could also be used for other interfaces in the RAN, for example where radio units implement higher layer functions near to the antennas.

Existing solutions based on CPRI implement an auto-negotiation mechanism in order to select the supported CPRI and eCPRI rates, according to CPRI specification chapter 4.5 (“Common Public Radio Interface (CPRI); Interface Specification” v7.0), while eCPRI networks can interoperate using Ethernet frames.

An incorrect match, or no match implies a loss of signal or a loss of frame for both parties, with a restart of the remote radio unit being possible. It is also noted that a remote radio unit does not switch on if there is a lack of CPRI protocol, and this can create a perpetual loop with the baseband unit trying to negotiate eCPRI with the remote radio unit.

WO 2021/215975 describes an approach to solve this problem by using a fallback negotiation mechanism in which the baseband unit and the remote radio unit sweep different bit rates, forward error connection (FEC) and protocol until both ends find a match for the bit rate and FEC. The baseband unit might try using the alternative protocols to connect to the remote site (selecting it by exclusion) but with a significant loss of time, spurious alarms and the risk of having to repeat or re-iterate the process in case of a restart of one of the nodes.

Some problems are envisaged with the existing approach. For example, conventional zero touch provisioning (ZTP) operates at a physical layer where it supports the alignment of bit rates and FEC between CPRI rates and eCPRI, assuming there is a direct link interconnecting BBU and RRU. The conventional techniques cover the case of automatic provisioning between the BBU and RRU, but it does not cover the case where the nodes belong to different operator networks and/or address spaces, and this check is performed only after the protocols are started.

This disclosure provides new mechanisms/methods that can be implemented in Radios (RRUs) and Basebands (BBUs), independently from their actual capability, in order to support the automatic setting up of the interface between them. The mechanism is based on the RAN protocol stacks that the Radio and Baseband are capable of using and provides verification of the respective capability and security as part of the protocol negotiation, before starting any upper layer protocols. In this way it is easier to detect an incorrect cable interconnection between the nodes, and to more quickly converge the ZTP process, since the capability and tags are exchanged as soon as the link (connection) is established.

The methods can be advantageously used to negotiate the fronthaul interface between local and remote units. Embodiments of the methods involve ‘RAN basic IO negotiation’ (RBIOS), check of link capability (e.g. supported rates, software (SW) version, administrative and security tags, etc.), and switch over and activation of required protocol stack/conversion.

Embodiments of method provide for the creation of selected eCPRI messages (RBIOS) to be used for basic and safe communication between the RAN units (RRU, BBU, FGW, RGW) to exchange capability info and Operations and Maintenance (O&M) messages between the RAN units.

According to a first aspect, there is provided a method of operating a method of operating a first unit in a radio access network, RAN, to configure a first interface with a second unit in the RAN. The first unit is capable of using one or more RAN protocol stacks for the first interface to the second unit. The method comprises receiving a first notification from the second unit, the first notification indicating one or more RAN protocol stack capabilities of the second unit for use over the first interface to the first unit; determining a RAN protocol stack to use for the first interface according to the one or more RAN protocol stack capabilities of the first unit and the one or more RAN protocol stack capabilities of the second unit; and configuring the first interface with the second unit according to the determined RAN protocol stack.

According to a second aspect, there is provided a computer program product comprising a computer readable medium having computer readable code embodied therein, the computer readable code being configured such that, on execution by a suitable computer or processor, the computer or processor is caused to perform the method according to the first aspect or any embodiment thereof.

According to a third aspect, there is provided a first unit for use in a radio access network, RAN, to configure a first interface with a second unit in the RAN. The first unit is capable of using one or more RAN protocol stacks for the first interface to the second unit. The first unit is configured to: receive a first notification from the second unit, the first notification indicating one or more RAN protocol stack capabilities of the second unit for use over the first interface to the first unit; determine a RAN protocol stack to use for the first interface according to the one or more RAN protocol stack capabilities of the first unit and the one or more RAN protocol stack capabilities of the second unit; and configure the first interface with the second unit according to the determined RAN protocol stack.

According to a fourth aspect, there is provided a first unit for use in a radio access network, RAN, to configure a first interface with a second unit in the RAN. The first unit is capable of using one or more RAN protocol stacks for the first interface to the second unit. The first unit comprises a processor and a memory, said memory containing instructions executable by said processor whereby said first unit is operative to receive a first notification from the second unit, the first notification indicating one or more RAN protocol stack capabilities of the second unit for use over the first interface to the first unit; determine a RAN protocol stack to use for the first interface according to the one or more RAN protocol stack capabilities of the first unit and the one or more RAN protocol stack capabilities of the second unit; and configure the first interface with the second unit according to the determined RAN protocol stack.

Thus, embodiments of the techniques described herein provide a mechanism for automatic zero-touch provisioning of RAN networks, even where the units in the RAN have a mix of different protocol stack capabilities. Every unit can implement the new startup protocol, independently from its capability, status and role in the network, radio and transport nodes.

In some embodiments, the startup protocol is based on new eCPRI messages over Ethernet, and allows for Packet Fronthaul ubiquitous setup, and eventually for switching back to CPRI in case any RAN node does not support the eCPRI full protocol.

The techniques can enable a full ‘plug-n-play’ fronthaul network where each unit can negotiate its protocols and line rate based on its capabilities, so avoiding connection and configuration errors, and avoiding the restart of units in case of configuration mismatches.

In some embodiments, the techniques allow the negotiation of Radio split option functions between the Radio unit and an Interworking Function (IWF) conversion function.

In additional embodiments, the techniques can be used in multi-operator and/or multi-tenant networks where a common fronthaul infrastructure is shared across different operators and it is necessary to implement interface segregation among different operator networks.

Embodiments of the techniques described herein can provide several other opportunities or advantages. For example, a connection scenario in which an intermediate unit provides additional protocol conversion capability, such as the case of Fronthaul Gateways (FGWs), can be managed. As another example, it can be checked that the units belong to the same operator and same address space before starting upper layer protocols, so preventing misconnections and misconfigurations, and each port can be tagged offline so that each node can verify during the new ZTP initialization phase.

Other benefits and advantages will be apparent to those skilled in the art.

### BRIEF DESCRIPTION OF THE DRAWINGS

Some of the embodiments contemplated herein will now be described more fully with reference to the accompanying drawings, in which:

FIG. 1 is a simplified illustration of a fronthaul interface between a baseband unit and a radio unit;

FIG. 2 is a simplified illustration of fronthaul interface between baseband units and radio units via a fronthaul gateway;

FIG. 3 is an example of a RAN node in accordance with some embodiments;

FIG. 4 is a simplified block diagram of a first unit according to various embodiments;

FIG. 5 is a diagram providing an overview of a unit according to some embodiments;

FIG. 6 is a signalling diagram illustrating a first exemplary negotiation of a RAN protocol stack for a fronthaul interface between a baseband unit and a radio unit via a fronthaul gateway;

FIG. 7 is a signalling diagram illustrating a second exemplary negotiation of a RAN protocol stack for a fronthaul interface between a baseband unit and a radio unit via a fronthaul gateway;

FIG. 8 is a signalling diagram illustrating a third exemplary negotiation of a RAN protocol stack for a fronthaul interface between a baseband unit and a radio unit via a fronthaul gateway; and

FIG. 9 is a flow chart illustrating a method of operating a first unit according to various embodiments.

### DETAILED DESCRIPTION

Some of the embodiments contemplated herein will now be described more fully with reference to the accompanying drawings. Other embodiments, however, are contained within the scope of the subject-matter disclosed herein, and the disclosed subject-matter should not be construed as limited to only the embodiments set forth herein; rather, these embodiments are provided by way of example to convey the scope of the subject-matter to those skilled in the art. While the embodiments are primarily described with reference to a fronthaul interface between a radio unit and a baseband unit, it will be appreciated that the embodiments are also applicable to RAN nodes having a different layer split, for example where higher layer functions are implemented near the antennas. Furthermore, while the embodiments are primarily described with reference to the units being capable of using RAN protocol stacks in the form of CPRI, eCPRI and proprietary variants thereof, it will be appreciated that units can also or alternatively be capable of using other types of RAN protocol stacks such as HLS midhaul protocols, and proprietary or standard Open RAN (O-RAN) protocols.

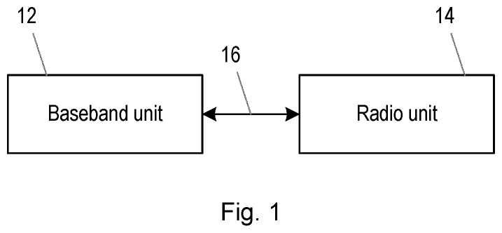

FIG. 1 is a simplified illustration of a fronthaul interface between a baseband unit and a radio unit. In particular, FIG. 1 shows a baseband unit (BBU) 12 connected to a radio unit (RU) 14 via a fronthaul interface 16. The radio unit 14 is also referred to as a remote radio unit (RRU). The connected BBU 12 and RU 16 form a radio access network (RAN) node that is used to provide an air interface for wireless devices in a communication network. A RAN node can also be referred to as a base station, eNodeB, eNB, gNB, gNodeB, etc. The fronthaul interface 16 can be provided by an optical connection (e.g. an optical fibre) or an electrical connection (e.g. copper wire).

The BBU 12 is provided for processing digital signals in the baseband frequencies of the communication network and the RU 14 typically converts the digital signals to the analog signals for transmission via one or more antennas, and vice versa.

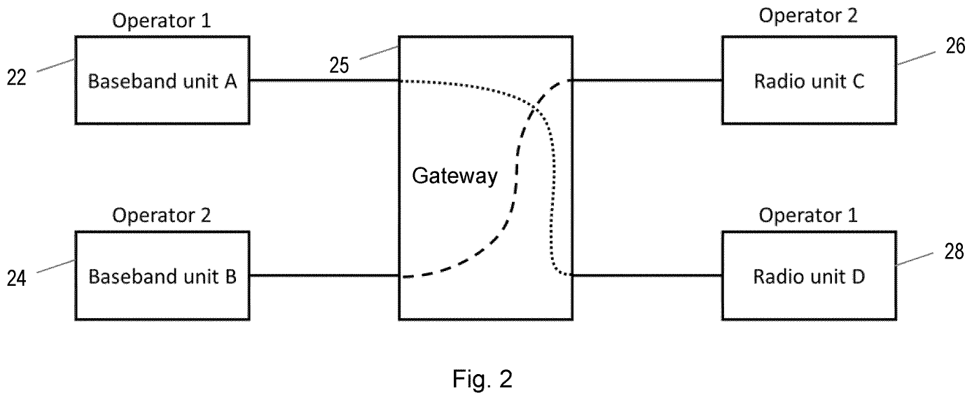

FIG. 2 is a simplified illustration of fronthaul interface between baseband units and radio units via a gateway node, for example a fronthaul gateway (FGW) or Radio Gateway (RGW). A gateway node can be connected to one or more BBUs and one or more RUs and provide switching capability to connect a particular BBU to a particular RU. A gateway node, particularly a FGW, may also provide a protocol stack conversion capability (i.e. between CPRI and e-CPRI) to enable a BBU configured for one type of protocol stack to communicate with a RU that uses another type of protocol stack. The arrangement in FIG. 2 can be used in a multi-operator network and/or a multi-tenant network, with the FGW/RGW ensuring that units are only connected to other units belonging to the same operator/tenant by using a suitable switching mechanism between the ports in the FGW/RGW. The units themselves can inform the FGW/RGW about which operator/tenant they belong to.

References to a protocol stack may alternatively refer to configuration to communicate using a protocol, a protocol type, signalling type, or other term indicating particular data communication protocols or systems.

FIG. 2 shows two BBUs, BBU A 22 and BBU B 24, connected to gateway node 25 (e.g. fronthaul gateway (FGW) or Radio Gateway (RGW) 25), and two RUs, RU C 26 and RU D 28 also connected to FGW/RGW 25. BBU A 22 and RU D 28 are owned or operated by Network Operator 1, and BBU B 24 and RU C 26 are owned or operated by Network Operator 2. The FGW/RGW 25 acts to interconnect BBU A 22 and RU D 28 to form a RAN node for Operator 1, and interconnects BBU B 24 and RU C 26 to form a RAN node for Operator 2. The fronthaul interface connections between the BBUs and the FGW/RGW 25 and the RUs and the FGW/RGW 25 can be provided by any combinations of optical connections and electrical connections.

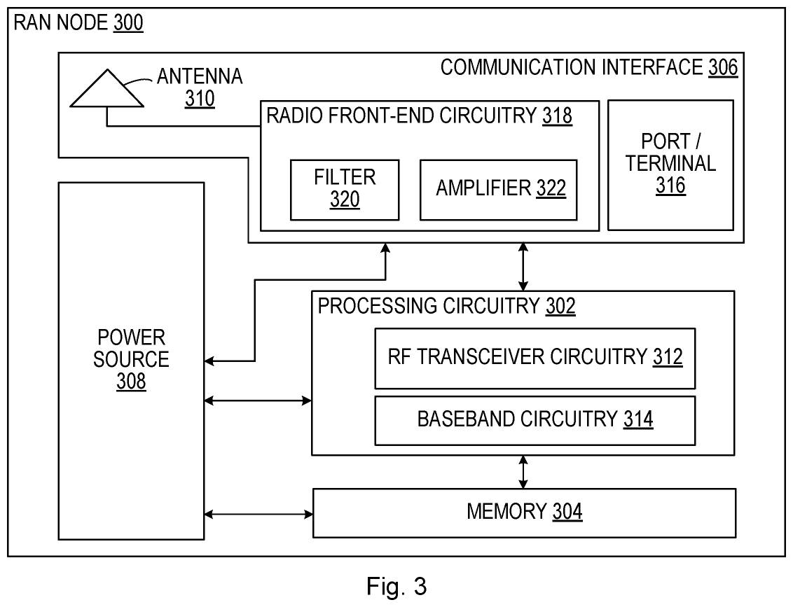

FIG. 3 shows a RAN node 300 in accordance with some embodiments formed by the interconnection of a BBU and a RU (either directly, or via a gateway node, such as a FGW/RGW). As used herein, ‘RAN node’ refers to equipment capable, configured, arranged and/or operable to communicate directly or indirectly with a User Equipment (UE) and/or with other RAN nodes or equipment, in a communication network. Examples of RAN nodes include, but are not limited to, RAN nodes such as access points (APs) (e.g. radio access points), base stations (BSs) (e.g. radio base stations, Node Bs, evolved Node Bs (eNBs) and New Radio (NR) NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay.

As noted, although shown as one entity in FIG. 3, the RAN node 300 is formed from parts of a distributed radio base station including a BBU and a RU or remote radio unit (RRU), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

The RAN node 300 includes processing circuitry 302, a memory 304, a communication interface 306, and a power source 308, and/or any other component, or any combination thereof. The RAN node 300 is composed of multiple physically separate components, which may each have their own respective components. In some embodiments, the RAN node 300 may be configured to support multiple radio access technologies (RATs). In such embodiments, some components may be duplicated (e.g. separate memory 304 for different RATs) and some components may be reused (e.g. a same antenna 310 may be shared by different RATs). The RAN node 300 may also include multiple sets of the various illustrated components for different wireless technologies integrated into RAN node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within RAN node 300.

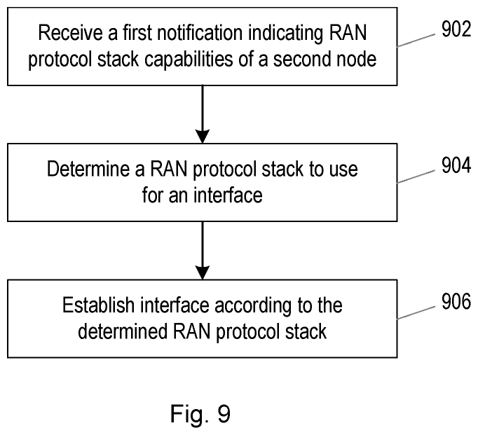

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other RAN node 300 components, such as the memory 304, to provide RAN node 300 functionality. For example, the processing circuitry 302 may be configured to cause the RAN node to perform the methods as described with reference to FIG. 9.

In some embodiments, the processing circuitry 302 includes a system on a chip (SOC). In some embodiments, the processing circuitry 302 includes one or more of radio frequency (RF) transceiver circuitry 312 and baseband processing circuitry 314. The radio frequency (RF) transceiver circuitry 312 is part of the RU, along with the communication interface 306, and a respective memory 304. The baseband processing circuitry 314, along with a respective memory 304, is part of the BBU.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signalling and/or data between RAN nodes, the access network, the core network, and/or a UE. As illustrated, the communication interface 306 comprises port(s)/terminal(s) 316 to send and receive data. The port(s)/terminal(s) 316 can send and receive data, for example to and from a network over a wired connection, such as optical fibres in a Transport Network. Alternatively or in addition, the port(s)/terminal(s) 316 can send and receive data between RAN nodes wirelessly via IAB connections and/or via a dedicated microwave Transport Network.

The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other RAN nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the RAN node 300 does not include separate radio front-end circuitry 318, instead, the RF transceiver circuitry 312 includes radio front-end circuitry and is connected to the antenna 310. Similarly, in some embodiments, all or some of the RF transceiver circuitry 312 is part of the communication interface 306.

The communication interface 306 includes one or more ports or terminals 316, so that the radio front-end circuitry 318, the RF transceiver circuitry 312 and the communication interface 306—as part of a radio unit (RU)—can connect to and communicate with the baseband processing circuitry 314, which is part of a BBU.

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the RAN node 300 and connectable to the RAN node 300 through an interface or port.

The antenna 310, communication interface 306, and/or the processing circuitry 302 may be configured to perform any receiving operations and/or certain obtaining operations described herein as being performed by the RAN node. Any information, data and/or signals may be received from a UE, another RAN node and/or any other network equipment. Similarly, the antenna 310, the communication interface 306, and/or the processing circuitry 302 may be configured to perform any transmitting operations described herein as being performed by the RAN node. Any information, data and/or signals may be transmitted to a UE, another RAN node and/or any other network equipment.

The power source 308 provides power to the various components of RAN node 300 in a form suitable for the respective components (e.g. at a voltage and current level needed for each respective component). The power source 308 may further comprise, or be coupled to, power management circuitry to supply the components of the RAN node 300 with power for performing the functionality described herein. For example, the RAN node 300 may be connectable to an external power source (e.g. the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the RAN node 300 may include additional components beyond those shown in FIG. 3 for providing certain aspects of the RAN node's functionality, including any of the functionality described herein and/or any functionality necessary to support the subject matter described herein. For example, the RAN node 300 may include user interface equipment to allow input of information into the RAN node 300 and to allow output of information from the RAN node 300. This may allow a user to perform diagnostic, maintenance, repair, and other administrative functions for the RAN node 300.

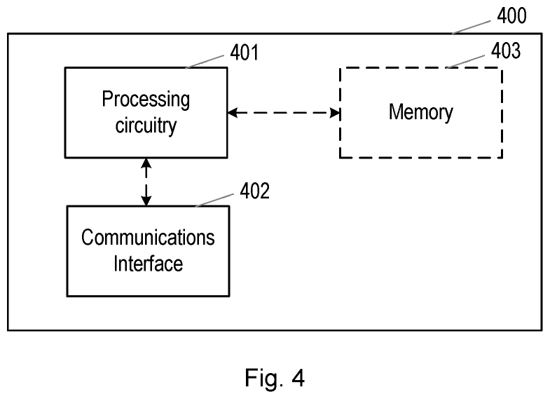

FIG. 4 is a block diagram of a unit 400 (also referred to as a ‘first unit’) according to various embodiments that can be used to implement the techniques described herein. As described further below, the unit 400 can be any of a baseband unit (BBU), a radio unit (RU), and a gateway node such as a fronthaul gateway (FGW) or Radio Gateway (RGW). The unit 400 can connect to and communicate with, other units, for example that are also configured and/or arranged as shown in FIG. 4.

The first unit 400 comprises processing circuitry (or logic) 401. It will be appreciated that the first unit 400 may comprise one or more virtual machines running different software and/or processes. The first unit 400 may therefore comprise one or more servers, switches and/or storage devices and/or may comprise cloud computing infrastructure that runs the software and/or processes.

The processing circuitry 401 controls the operation of the first unit 400 and can implement the methods described herein in relation to the first unit 400. The processing circuitry 401 can comprise one or more processors, processing units, multi-core processors or modules that are configured or programmed to control the first unit 400 in the manner described herein. In particular implementations, the processing circuitry 401 can comprise a plurality of software and/or hardware modules that are each configured to perform, or are for performing, individual or multiple steps of the method described herein in relation to the first unit 400.

The first unit 400 also comprises a communications interface 402. The communications interface 402 is for use in communicating with other units, such as other ‘first units’, conventional BBUs, conventional RUs, conventional FGWs, conventional RGWs, etc. For example, the communications interface 402 can be configured to transmit to and/or receive from other units requests, acknowledgements, information, data, signals, or similar. The processing circuitry 401 may be configured to control the communications interface 402 to transmit to and/or receive from other units requests, acknowledgements, information, data, signals, or similar, according to the methods described herein.

The communications interface 402 can provide an electrical and/or optical interface for conveying signals. Such interfaces can be compliant with a suitable electrical or optical-based standard, such as those defined in IEEE 802.3, for example Ethernet. The communications interface 402 can support any common Ethernet types and speeds, e.g. 10G, 25G, 40G, and 100G Ethernet, and other line rates/interface types.

Optionally, the first unit 400 may comprise a memory 403. In some embodiments, the memory 403 can be configured to store program code that can be executed by the processing circuitry 401 to perform the method described herein in relation to the first unit 400. Alternatively or in addition, the memory 403 can be configured to store any requests, acknowledgements, information, data, signals, or similar that are described herein. The processing circuitry 401 may be configured to control the memory 403 to store such information therein.

As noted above, the techniques described herein provide new mechanisms to be implemented in new Radios (RUs), Basebands (BBUs) and gateway nodes such as fronthaul gateways (FGWs)/radio gateways (RGWs), independently from their actual capability, in order to support the automatic setting up of the interface, based on Radio and Baseband capabilities with verification of the respective capability and security as part of the protocol negotiation, before starting any upper layer protocols. In this way it is easier to detect incorrect cable interconnections and make it faster to converge the ZTP process since the capability and tags can be exchanged as soon as the physical link is established. The methods can be advantageously used to negotiate the fronthaul interface between local and remote units. Embodiments of the methods involve ‘RAN basic IO negotiation’ (RBIOS), check of link capability (e.g. supported rates, software (SW) version, administrative and security tags, etc.), and switch over and activation of required protocol stack/conversion

The methods can be applied to various types and/or generations of network, and for example the methods can be applied to 5^{th} Generation (5G) split architectures and Cloud RAN applications where the role of each unit (RRU, BBU, Fronthaul Gateway (FHG), Radio Gateway (RGW) can be flexibly orchestrated and changed dynamically.

Embodiments of method make use of selected eCPRI messages (collectively referred to herein as ‘RBIOS’) for basic and safe communication between the RAN nodes (RRU, BBU, FHG, RGW) to exchange capability info and Operations and Maintenance (O&M) messages between the RAN units. Such eCPRI messages can be safely supported on dedicated eCPRI PHY (physical layer) as an alternative to traditional Ethernet PHY used for eCPRI interface and can be deployed in any RAN unit independently from their Low-Level Split (LLS) capability.

The RBIOS connects first using Ethernet framing (only low levels) to encode information about any one or more of:
The RAN protocol stack supported (e.g. CPRI, eCPRI, proprietary CPRI, proprietary eCPRI, etc.);
The LLS split supported (e.g. CPRI, LLS split 7.2, a proprietary LLS, LLS split 3);
The vendor (e.g. manufacturer of the unit) and SW version labels;
The group identity (e.g. the operator of the unit, or other groups);
The capability to convert between formats/protocols;
Optional security and authentication messages (which can be vendor specific).

Upon establishment of the link connection between the units (e.g. when the units are plugged in and switched on), the units start the basic RBIOS using existing auto-negotiation mechanisms. Once the connection is established the PHY layers can exchange their security and capability info.

Upon verification of vendor and SW version compatibility (which can be optional), the end units can negotiate the LLS split to be used. Upon link disconnection or link failure, the PHY layers can revert back to RBIOS for the next negotiation, making the process fully automated.

It is noted that this method can be implemented as an extension of eCPRI 2.0 IWF as a method to switch on/off the IWF automatically based on the connected client.

Using this methodology, any Radio Unit and Baseband Unit will start up with common signalling in order to initiate the connection between local and remote ports (units). Eventually the two ports (units) negotiate their capability, with the outcome of the negotiation being typically any of:
Both units support eCPRI full stack with compatibility stack (Open-RAN (O-RAN), Proprietary eCPRI variants, etc.);
Both units pertain to the same vendor or customer subnetwork (equipment shared across different operators);
The Radio unit does not support eCPRI full stack and needs to revert to CPRI;
The Baseband unit is already allocated to CPRI and cannot support eCPRI on this port (e.g. in case of legacy baseband limitations).

It is noted that, if only CPRI is supported on both sides, the two units can switch-back the interface rate (i.e. the connection speed) and FEC into one of the supported CPRI line rates. If the remote Radio unit is legacy (i.e. only supporting CPRI), the Baseband unit can revert to CPRI on the selected port, trying to lock-in on the CPRI interface.

The above method can be summarised as follows.

A method implemented on RAN local and remote ports/units used to communicate their role and negotiate their respective LLS functions (RAN protocol stack) using a simplified protocol message, called RBIOS herein, to be implemented by any RAN node independently from its capability and role. The RBIOS can be based on the Ethernet physical interface and use the eCPRI EtherType. RBIOS can use extensions of eCPRI messages not yet allocated by the CPRI forum. The RBIOS can carry information about the local and the remote unit relevant to role, LLS (stack) capability and administrative parameters. If the administrative parameters (such as network name, address area, port labels) of the different units do not match, the ZTP procedure can be aborted, and a message can be sent to a management interface of the BBU, RU, etc.

According to this method, if a unit (i.e. an RU or BBU) supports the RBIOS but does not support eCPRI full interface (proprietary eCPRI variants or O-RAN), the local and remote ports negotiate the supported CPRI rate and then switch-over at the same time.

The method can be used where one of the units is a gateway node such as a Fronthaul Gateway, supporting either or both of proprietary or O-RAN/CPRI protocol conversion, and the FGW/RGW can expose this conversion capability to the neighbouring (connected) units.

The method can also provide that if communication between the units is lost, or the upper layer applications do not handshake a compatible protocol, RBIOS renegotiation can be restarted independently on each involved unit.

It is assumed in the following that any optical modules (e.g. small form-factor pluggable (SFP), SFP+, SFP28, Quad SFP (QSFP), etc.) used in a RRU or a BBU are capable of supporting CPRI and Ethernet bitrates.

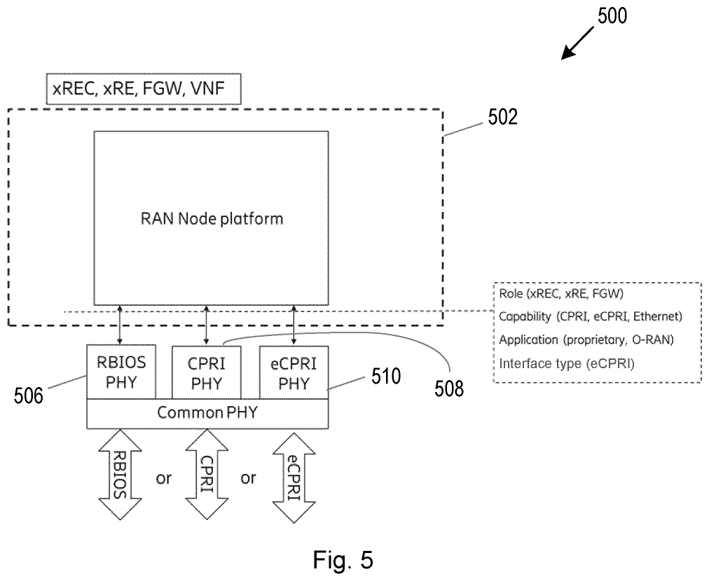

FIG. 5 is a diagram providing an overview of a unit 500 according to some embodiments. In particular FIG. 5 shows how RBIOS can be run as part of the PHY function and does not require any RAN-specific application. The unit 500 comprises a RAN Node platform 502, i.e. the hardware/software implementing the unit 500. The unit 500 can be any of a REC, RE, FGW, RGW or virtual network function (VNF). The RAN node platform 502 has a particular Role (e.g. REC, RE, FGW, etc.), a Capability (e.g. CPRI, eCPRI, Ethernet, etc.), an Application (e.g. proprietary, O-RAN, etc.) and an Interface Type (e.g. eCPRI, etc.). The RAN node platform 502 has three physical layer (PHY) ports: an RBIOS PHY port 506, a CPRI PHY port 508 and an eCPRI PHY port 510.

With the method described herein, the RRU, BBU and FGW/RGW units are able to start in Ethernet mode supporting the simplified RBIOS protocol with specific O&M messages used to negotiate the link capability. As part of the negotiation, the units communicate their role, their capability and if both BBU and RRU support eCPRI of the same type (O-RAN, proprietary eCPRI) then eCPRI is negotiated and the FGW/RGW enables Ethernet switching between the attached ports. Thus there is an independent RBIOS-based negotiation of LLS layers, and then a separate negotiation of high layer split (HLS) layers. HLS layers can include any of F1, E1 and E5 interfaces, so IP fronthaul interfaces used by Distributed Units (DUs) and Centralised Units (CUs).

Some exemplary negotiation outcomes are set out in the next paragraph.
If both the BBU and the RRU can support eCPRI and the same application layer (e.g. proprietary eCPRI variant supported), eCPRI is negotiated and the FGW/RGW enables Ethernet switching between the attached ports.
If both the BBU and the RRU can support eCPRI but they do not support compatible high layer split (HLS) layers, the lowest compatibility mode (e.g. CPRI/proprietary CPRI variant) is negotiated and the FGW/RGW enables direct cross-connection between the attached ports.
If both the BBU and RRU can support only CPRI then they select the CPRI rates and the FGW/RGW enables direct cross-connection between the attached ports.
If the BBU supports eCPRI and the RRU supports only CPRI, the FGW/RGW checks if it can support the required application layer for BBU and enables conversion.
In case of no compatibility, all the nodes revert to RBIOS waiting for new connection.
In case of RU or BBU unit restart, loss of communication or upper layer protocol mismatch, the RBIOS protocol negotiation is restarted on both sides independently until a new protocol handshake is completed.

In some embodiments, the BBU, RRU and/or FGW/RGW can communicate administrative information, such as unit inventory, assigned customer network, assigned address area and port labels configured offline or from factory.

Thus, the method described above checks the consistency of communication parameters before starting any protocol negotiation.

Exemplary implementations of the RBIOS protocol are described below.

In some embodiments, RBIOS is based on eCPRI protocol extensions in order to maintain backward compatibility with existing networks/units. An exemplary set of messages and relevant semantics are specified below. However, RBIOS can be carried over alternative physical layer protocols such as CPRI.

RBIOS is based on eCPRI using vendor specific Message Type field in the eCPRI Common Header (range 64-255—see chapter 3.2.3 and Table 4 in eCPRI Specification v2.0). For instance, Message Type=128 (hex 80) can be chosen to identify the RBIOS extension.

The RBIOS message can be included in the eCPRI payload using a variable number of bytes. A possible syntax is as follows:

Byte

| number | Semantic | |
|---|---|---|
| 0 | identify RBIOS message type: 0 −> capability advertising, 1 −> command/response, 2-255 −> for | |
| | further extension | |
| | Case 0: capability advertising | Case 1: command/response |
| 1 | CPRI capabilities: 0 −> no CPRI, N (1-255) | command (0 −> No Command, 1 −> Switch, 2 −> |
| | identifies a particular CPRI version (standard or | warm restart, 3-255 −> for further extensions) |
| | vendor specific) | |
| 2 | eCPRI capabilities: 0 −> no eCPRI (see note | 0 −> command sent |
| | below), N (1-255) −> identifies a particular CPRI | 1 −> command acknowledged |
| | version (standard or vendor specific) | 2 −> command not acknowledged |
| 3 | conversion capabilities: 0 −> no conversion, 1 −> | command argument (e.g., for “switch”: 0 −> |
| | CPRI or proprietary CPRI variant/eCPRI or | CPRI, 1 −> eCPRI) |
| | proprietary eCPRI variant, 2 −> CPRI or proprietary | or Error Code if command not acknowledged |
| | CPRI variant/ORAN, 3 −> eCPRI or proprietary | |
| | eCPRI variant/ORAN, 4-255 −> for further | |
| | extensions | |
| 4 | Acknowledge of other side capabilities: | Not used |
| | 0 −> no, 1 −> yes | |
| 5 | operator ID (to support multi-operator FH | Not used |
| | networks). Assignment of ID numbers is done at | |
| | network management level | |

Note:
No eCPRI means that only RBIOS messaging is supported.
Word padding is added as from standard eCPRI protocol.

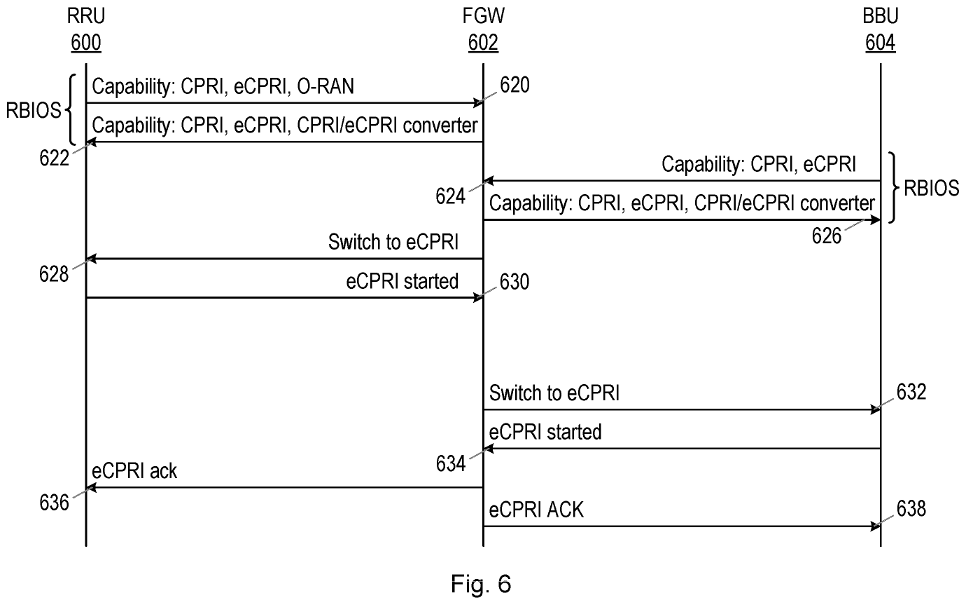

The signalling diagrams in FIGS. 6, 7 and 8 show respective exemplary 3-way handshakes using the above-described RBIOS protocol. That is, FIGS. 6, 7 and 8 shows the signalling between RRU 600 and FGW 602, and between FGW 602 and BBU 604, to establish a connection between RRU 600 and BBU 604. It will be appreciated that in some embodiments the gateway node 602 may alternatively be a RGW. Each of RRU 600, FGW 602 and BBU 604 are configured to use the RBIOS protocol described herein. Those skilled in the art will appreciate from FIGS. 6-8 and the above description how the RBIOS protocol operates in embodiments where a FGW/RGW is not present. In FIGS. 6-8 and the description below, reference is made to CPRI and eCPRI for ease of illustration and explanation, but it will be appreciated that in practical implementations capabilities can include proprietary variants of CPRI and/or eCPRI, in addition to or instead of standard CPRI and eCPRI.

Once RBIOS negotiates the preferred communication protocol stack, the preferred protocol stack is established, and the RAN upper layer application(s) can start. In the event of failure due to RAN function incompatibility, the RBIOS protocol is partially restarted (e.g. there can be capability renegotiation-referred to as a ‘warm restart’). In the case of a temporary loss of communications, the RBIOS protocol can be fully restarted to prevent any misconnection case (e.g. there can be protocol renegotiation-referred to as a ‘cold restart’).

It is noted that, at start-up, the RRU 600, FGW 602 and BBU 604 run the RBIOS protocol independently and converge due to the RBIOS protocol message exchange. It will be appreciated that the temporal order of some of the signals in the signalling diagrams is exemplary, and the signals can occur in a different order in practice.

In FIG. 6, initially the RRU 600 and the BBU 604 are connected to the FGW 602, e.g. via an electrical or optical connection. Then, the RRU 600 and the FGW 602 signal their respective RAN protocol stack capabilities to each other, and the BBU 604 and the FGW 602 signal their respective RAN protocol stack capabilities to each other. In this exemplary use case, the RRU 600 can use CPRI, eCPRI and O-RAN, and the BBU 604 can also use CPRI and eCPRI. The BBU 604 has a preference for using eCPRI in order to aggregate the traffic, as the RRU 600 also supports eCPRI. The FGW 602 therefore has RBIOS ports facing eCPRI. Thus, the FGW 602 enables eCPRI switching between the RBIOS ports that the RRU 600 and the BBU 604 are connected to, and starts the eCPRI protocol stacks.

In more detail, signal 620 shows the RRU 600 signalling its RAN protocol stack capabilities for a fronthaul interface to the FGW 602. In this embodiment, signal 620 shows the RAN protocol stack capabilities of the RRU 600 as CPRI, eCPRI and O-RAN. Signal 622 shows the FGW 602 signalling its RAN protocol stack capabilities for the fronthaul interface to the RRU 600. In this embodiment, signal 622 shows the RAN protocol stack capabilities of the FGW 602 as eCPRI and conversion between CPRI and eCPRI.

Signal 624 shows the BBU 604 signalling its RAN protocol stack capabilities for a fronthaul interface to the FGW 602. In this embodiment, signal 624 shows the RAN protocol stack capabilities of the BBU 604 as CPRI and eCPRI. Signal 626 shows the FGW 602 signalling its RAN protocol stack capabilities for the fronthaul interface to the BBU 604. In this embodiment, signal 626 shows the RAN protocol stack capabilities of the FGW 602 as CPRI, eCPRI and conversion between CPRI and eCPRI (the same as signal 622).

It will be appreciated that signals 620, 622, 624 and 626 can occur in any order, and the order shown in FIG. 6 is merely exemplary.

The FGW 602 determines that the RRU 600, the FGW 602 and the BBU 604 all support eCPRI (the best available protocol stack for the fronthaul interface), and therefore determines that eCPRI should be used. The FGW 602 therefore signals to the RRU 600, via signal 628, to switch to using eCPRI signalling. The RRU 600 switches to eCPRI and confirms this to the FGW 602 (signal 630). The FGW 602 likewise signals to the BBU 604, via signal 632, to switch to using eCPRI signalling. The BBU 604 switches to eCPRI and confirms this to the FGW 602 (signal 634). It will be appreciated that signals 628, 630, 632 and 634 can occur in any order, and the order shown in FIG. 6 is merely exemplary.

Once the FGW 602 has received signal 630, it sends an acknowledgment signal 636 to the RRU 600 confirming that eCPRI is being used, and once the FGW 602 has received signal 634, it sends an acknowledgment signal 638 to the BBU 604 confirming that eCPRI is being used.

Communications between the RRU 600 and the BBU 604 can then proceed with both the RRU 600 and the BBU 604 using eCPRI.

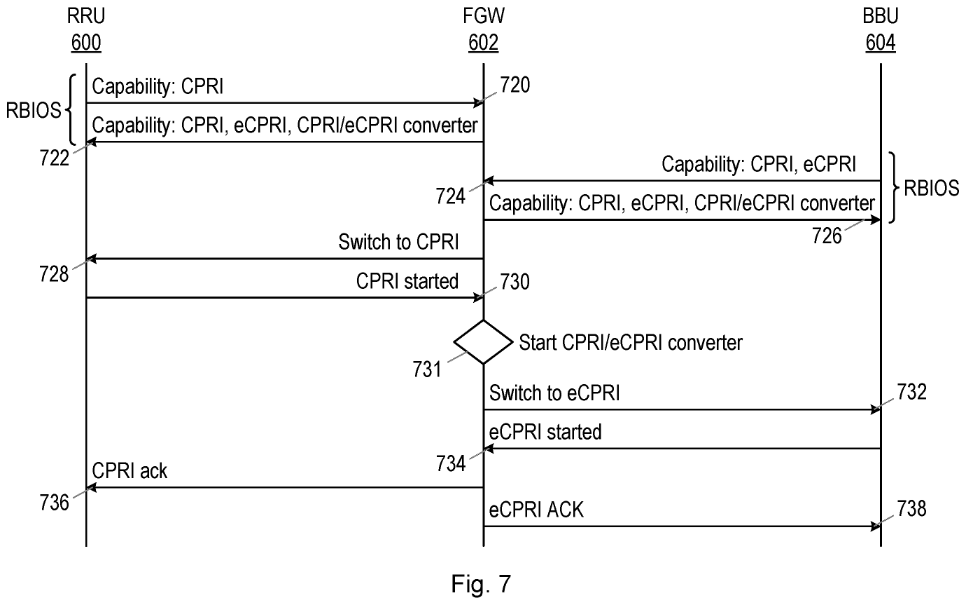

In the exemplary use case in FIG. 7, the RRU 600 can use CPRI, and the BBU 604 can use CPRI and eCPRI. The BBU 604 has a preference for using eCPRI in order to aggregate the traffic, but the RRU 600 can only support CPRI. The FGW 602 therefore has one RBIOS port facing eCPRI and CPRI (the port connected to the BBU 604), and another RBIOS port facing CPRI (the port connected to the RRU 600). However, the FGW 602 is capable of converting between eCPRI and CPRI. Therefore the FGW 602 connects the two RBIOS ports that the RRU 600 and the BBU 604 are connected to, enables CPRI/eCPRI conversion on that connection, and enables the CPRI and eCPRI protocols on those ports respectively.

In more detail, signal 720 shows the RRU 600 signalling its RAN protocol stack capabilities for a fronthaul interface to the FGW 602. In this embodiment, signal 720 shows the RAN protocol stack capabilities of the RRU 600 as CPRI. Signal 722 shows the FGW 602 signalling its RAN protocol stack capabilities for the fronthaul interface to the RRU 600. In this embodiment, signal 722 shows the RAN protocol stack capabilities of the FGW 602 as CPRI, eCPRI, and conversion between CPRI and eCPRI.

Signal 724 shows the BBU 604 signalling its RAN protocol stack capabilities for a fronthaul interface to the FGW 602. In this embodiment, signal 724 shows the RAN protocol stack capabilities of the BBU 604 as CPRI and eCPRI. Signal 726 shows the FGW 602 signalling its RAN protocol stack capabilities for the fronthaul interface to the BBU 604.

In this embodiment, signal 727 shows the RAN protocol stack capabilities of the FGW 602 as CPRI, eCPRI and conversion between CPRI and eCPRI (the same as signal 722).

It will be appreciated that signals 720, 722, 724 and 726 can occur in any order, and the order shown in FIG. 7 is merely exemplary.

The FGW 602 determines that the RRU 600 only supports CPRI, and therefore that CPRI should be used on the port with the RRU 600. The FGW 602 determines that the BBU 604 supports eCPRI, and that the FGW 602 is capable of converting between CPRI and eCPRI. Therefore the FGW 602 determines that eCPRI should be used with the BBU 604, and conversion between CPRI and eCPRI should be used between the RRU 600 and the BBU 604. The FGW 602 therefore signals to the RRU 600, via signal 728, to switch to using CPRI signalling. The RRU 700 switches to CPRI and confirms this to the FGW 602 (signal 730). At step 731 the FGW 602 starts the CPRI/eCPRI conversion. The FGW 602 signals to the BBU 604, via signal 732, to switch to using eCPRI signalling. The BBU 604 switches to eCPRI and confirms this to the FGW 602 (signal 734). It will be appreciated that signals 728, 730, 732 and 734 can occur in any order, and the order shown in FIG. 7 is merely exemplary.

Once the FGW 602 has received signal 730, it sends an acknowledgment signal 737 to the RRU 600 confirming that CPRI is being used, and once the FGW 602 has received signal 734, it sends an acknowledgment signal 738 to the BBU 604 confirming that eCPRI is being used.

Communications between the RRU 600 and the BBU 604 can then proceed with the RRU 600 using CPRI and the BBU 604 using eCPRI.

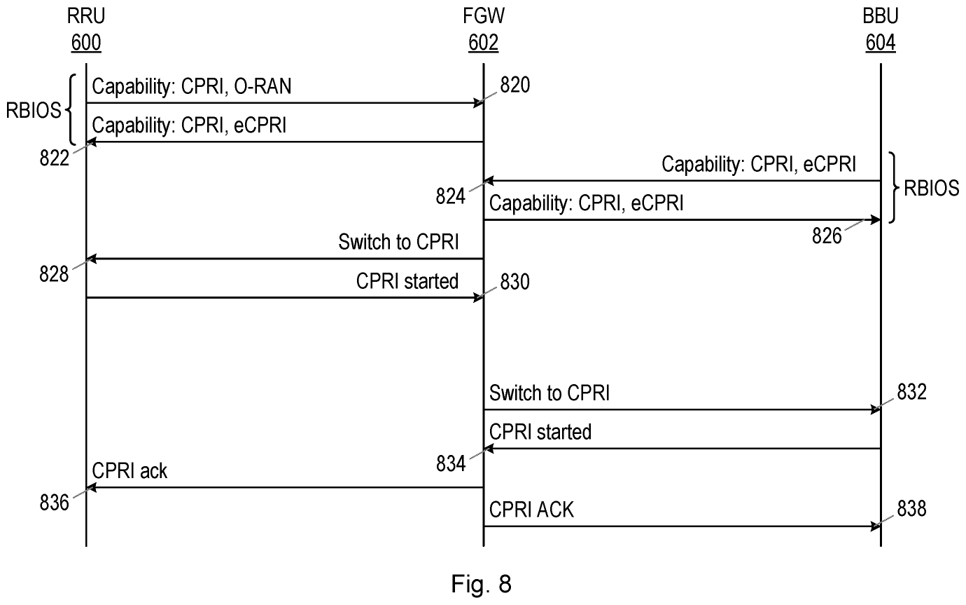

In the exemplary use case in FIG. 8, the RRU 600 can use CPRI and O-RAN, and the BBU 604 can use CPRI and eCPRI. The BBU 604 has a preference for using eCPRI in order to aggregate the traffic, but the RRU 600 can only support CPRI. The FGW 602 therefore has one RBIOS port facing eCPRI and CPRI (the port connected to the BBU 604), and another RBIOS port facing CPRI (the port connected to the RRU 600). In this use case, the FGW 602 is not capable of converting between eCPRI and CPRI. Therefore the FGW 602 connects the two RBIOS ports that the RRU 600 and the BBU 604 are connected to, and enables the CPRI protocols on both ports.

In more detail, signal 820 shows the RRU 600 signalling its RAN protocol stack capabilities for a fronthaul interface to the FGW 602. In this embodiment, signal 820 shows the RAN protocol stack capabilities of the RRU 600 as CPRI and O-RAN. Signal 822 shows the FGW 602 signalling its RAN protocol stack capabilities for the fronthaul interface to the RRU 600. In this embodiment, signal 822 shows the RAN protocol stack capabilities of the FGW 602 as CPRI, and eCPRI.

Signal 824 shows the BBU 604 signalling its RAN protocol stack capabilities for a fronthaul interface to the FGW 602. In this embodiment, signal 824 shows the RAN protocol stack capabilities of the BBU 604 as CPRI and eCPRI. Signal 826 shows the FGW 602 signalling its RAN protocol stack capabilities for the fronthaul interface to the BBU 604. In this embodiment, signal 828 shows the RAN protocol stack capabilities of the FGW 602 as CPRI, and eCPRI (the same as signal 822).

It will be appreciated that signals 820, 822, 824 and 826 can occur in any order, and the order shown in FIG. 8 is merely exemplary.

As the FGW 602 does not have the capability to convert between protocols, the FGW 602 identifies the common protocol stack(s) between the RRU 600 and the BBU 604. In this case, the protocol stack(s) common to both the RRU 600 and the BBU 604 is CPRI. Therefore the FGW 602 determines that CPRI should be used on the port with the RRU 600 and the port with the BBU 604. The FGW 602 therefore signals to the RRU 600, via signal 828, to switch to using CPRI signalling. The RRU 800 switches to CPRI and confirms this to the FGW 602 (signal 830). The FGW 602 signals to the BBU 604, via signal 832, to switch to using CPRI signalling. The BBU 604 switches to CPRI and confirms this to the FGW 602 (signal 834). It will be appreciated that signals 828, 830, 832 and 834 can occur in any order, and the order shown in FIG. 8 is merely exemplary.

Once the FGW 602 has received signal 830, it sends an acknowledgment signal 838 to the RRU 600 confirming that CPRI is being used, and once the FGW 602 has received signal 834, it sends an acknowledgment signal 838 to the BBU 604 confirming that CPRI is being used.

Communications between the RRU 600 and the BBU 604 can then proceed using CPRI.

FIG. 9 is a flow chart illustrating a method according to various embodiments performed by a first unit. The first unit is in a RAN, and the method is for configuring a first interface with a second unit in the RAN. In some embodiments, the first interface is a fronthaul interface. The first unit may perform the method in response to executing suitably formulated computer readable code. The computer readable code may be embodied or stored on a computer readable medium, such as a memory chip, optical disc, or other storage medium. The computer readable medium may be part of a computer program product.

The first unit is capable of using one or more RAN protocol stacks for the first interface to the second unit.

The method in FIG. 9 can be performed any of: when the first unit is activated, when the second unit is activated, when the first unit is initially physically connected to the second unit, or if a link to the second unit or another unit in the RAN fails or is disconnected.

Step 902 comprises the first unit receiving a first notification from the second unit. The first notification indicates one or more RAN protocol stack capabilities of the second unit for use over the first interface to the first unit. In some embodiments, the first notification received in step 902 further comprises any of: a capability of the second unit to convert traffic according to one RAN protocol stack to another RAN protocol stack, a version number for any RAN protocol stack that the second unit is capable of using, information indicating a function or type of the second unit, operator information indicating a network operator associated with the second unit, and administrative information.

In step 904, the first unit determines a RAN protocol stack to use for the first interface according to the one or more RAN protocol stack capabilities of the first unit and the one or more RAN protocol stack capabilities of the second unit.

In step 906, the first unit configures the first interface with the second unit according to the determined RAN protocol stack.

In some embodiments, step 904 comprises selecting a RAN protocol stack that is common to the one or more capabilities of the first unit and the one or more capabilities of the second unit. In some embodiments, in the event that multiple RAN protocol stacks are common to first unit and the second unit, step 904 can comprise selecting the RAN protocol stack that satisfies a predefined criterion. The predefined criterion can be satisfied by the RAN protocol stack with one of: the highest data rate, the highest throughput, the highest layer split, or the highest functional level.

In some embodiments, each RAN protocol stack that the first unit and/or the second unit is capable of using comprises one or more of: a LLS fronthaul protocol, a HLS midhaul protocol, a proprietary O-RAN protocol, and a standard O-RAN protocol. In some embodiments, the one or more RAN protocol stack capabilities comprise one or more of: a capability to use a CPRI protocol, a capability to use an eCPRI protocol, and one or more supported CPRI options.

In some embodiments, the method further comprises the first unit sending a second notification to the second unit. The second notification indicates the one or more RAN protocol stack capabilities of the first unit. In these embodiments, the second notification can further comprises any of: a capability of the first unit to convert traffic according to one RAN protocol stack to another RAN protocol stack, a version number for any RAN protocol stack that the first unit is capable of using, information indicating a function or type of the first unit, operator information indicating a network operator associated with the first unit, and administrative information.

In any of the above embodiments, the first notification can be received using an Ethernet-based protocol. In any of the above embodiments, the first notification can be received via an electrical or optical connection between the first unit and the second unit.

In some embodiments, the first unit is a BBU and the second unit is one of a radio unit and a gateway node.

In alternative embodiments, the first unit is a radio unit and the second unit is one of a BBU and a gateway node.

In some embodiments, the first unit is a gateway node. In these embodiments, the gateway node is additionally to establish a second interface with a third unit in the RAN to enable communications between the second unit and the third unit via the gateway node. In these embodiments, the first unit can be one of a radio unit and a BBU, and the second unit can be the other one of the radio unit and the BBU.

In some embodiments, the method further comprises: receiving a third notification from the third unit. The third notification indicates one or more RAN protocol stack capabilities of the second unit for use over the second interface. The first unit then determines a RAN protocol stack to use for the second interface with the third unit according to the one or more RAN protocol stack capabilities of the first unit and the one or more RAN protocol stack capabilities of the third unit; and establishes the second interface with the third unit according to the determined RAN protocol stack. In these embodiments, the steps of determining RAN protocol stacks to use for the first interface and the second interface can take into account a capability of the first unit to convert traffic according to one RAN protocol stack to another RAN protocol stack. In these embodiments, the method by the first unit can further comprise receiving traffic from one of the second unit via the first interface and the third unit via the second interface, and sending the received traffic to the other one of the second unit via the first interface and the third unit via the second interface. In some embodiments, if the RAN protocol stack used for the first interface is different to the RAN protocol stack used for the second interface, the first unit can convert the received traffic to the RAN protocol stack used for the other one of the first interface and the second interface, so that the converted traffic is sent to the other one of the second unit via the first interface and the third unit via the second interface.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

1. A method of operating a first unit in a radio access network (RAN) to configure a first interface with a second unit in the RAN, wherein the first unit is capable of using one or more RAN protocol stacks for the first interface to the second unit, the method comprising:
receiving a first notification from the second unit, the first notification indicating one or more RAN protocol stack capabilities of the second unit for use over the first interface to the first unit;
determining a RAN protocol stack to use for the first interface according to the one or more RAN protocol stack capabilities of the first unit and the one or more RAN protocol stack capabilities of the second unit; and
configuring the first interface with the second unit according to the determined RAN protocol stack.

2. The method as claimed in claim 1, wherein the step of determining the RAN protocol stack to use comprises selecting a RAN protocol stack that is common to the one or more capabilities of the first unit and the one or more capabilities of the second unit.

3. The method as claimed in claim 2, wherein, in the event that a plurality of RAN protocol stacks are common to first unit and the second unit, the step of determining the RAN protocol stack to use comprises selecting the RAN protocol stack in the plurality of RAN protocol stacks that satisfies a predefined criterion.

4. The method as claimed in claim 3, wherein the predefined criterion is satisfied by the RAN protocol stack with one of: the highest data rate, the highest throughput, the highest layer split, or the highest functional level.

5. The method as claimed in claim 1, wherein each RAN protocol stack that the first unit and/or the second unit is capable of using comprises one or more of:
a Lower Layer Split (LLS) fronthaul protocol;
a High Layer Split (HLS) midhaul protocol;
a proprietary open-RAN (O-RAN) protocol; and
a standard O-RAN protocol.

6. The method as claimed in claim 1, wherein the one or more RAN protocol stack capabilities comprise one or more of: a capability to use a Common Public Radio Interface (CPRI) protocol, a capability to use an enhanced-CPRI (eCPRI) protocol, and one or more supported CPRI options.

7. The method as claimed in claim 1, wherein the first notification further comprises any of: a capability of the second unit to convert traffic according to one RAN protocol stack to another RAN protocol stack, a version number for any RAN protocol stack that the second unit is capable of using, information indicating a function or type of the second unit, operator information indicating a network operator associated with the second unit, and administrative information.

8. The method as claimed in claim 1, wherein the method further comprises:
sending a second notification to the second unit, the second notification indicating the one or more RAN protocol stack capabilities of the first unit.

9. The method as claimed in claim 8, wherein the second notification further comprises any of: a capability of the first unit to convert traffic according to one RAN protocol stack to another RAN protocol stack, a version number for any RAN protocol stack that the first unit is capable of using, information indicating a function or type of the first unit, operator information indicating a network operator associated with the first unit, and administrative information.

10. The method as claimed in claim 1, wherein the first notification is received using an Ethernet-based protocol.

11. The method as claimed in claim 1, wherein the first notification is received via an electrical or optical connection between the first unit and the second unit.

12. The method as claimed in claim 1, wherein the method is performed any of: when the first unit is activated; when the second unit is activated; when the first unit is initially physically connected to the second unit; if a link to the second unit or another unit in the RAN fails or is disconnected.

13. The method as claimed in claim 1, wherein the first unit is a baseband unit (BBU) and the second unit is one of a radio unit and a gateway node.

14. The method as claimed in claim 1, wherein the first unit is a radio unit and the second unit is one of a baseband unit (BBU) and a gateway node.

15. The method as claimed in claim 1, wherein the first unit is a gateway node.

16. The method as claimed in claim 15, wherein the gateway node is to establish a second interface with a third unit in the RAN to enable communications between the second unit and the third unit via the gateway node.

17. The method as claimed in claim 16, wherein the first unit is one of a radio unit and a baseband unit (BBU) and the second unit is the other one of the radio unit and the BBU.

18. The method as claimed in claim 16, wherein the method further comprises:
receiving a third notification from the third unit, the third notification indicating one or more RAN protocol stack capabilities of the second unit for use over the second interface;
determining a RAN protocol stack to use for the second interface with the third unit according to the one or more RAN protocol stack capabilities of the first unit and the one or more RAN protocol stack capabilities of the third unit; and
establishing the second interface with the third unit according to the determined RAN protocol stack.

19-22. (canceled)

23. A non-transitory computer-readable medium having stored thereon computer-executable instructions that, on execution by a suitable computer or processor, cause the computer or the processor to execute operations, the operations comprising:
receiving a first notification from a second unit, the first notification indicating one or more RAN protocol stack capabilities of the second unit for use over the first interface to the unit;
determining a RAN protocol stack to use for the first interface according to the one or more RAN protocol stack capabilities of the first unit and the one or more RAN protocol stack capabilities of the second unit; and
configuring a first interface with the second unit according to the determined RAN protocol stack.

24. A first unit for use in a radio access network (RAN) to configure a first interface with a second unit in the RAN, wherein the first unit is capable of using one or more RAN protocol stacks for the first interface to the second unit, the first unit configured to:
receive a first notification from the second unit, the first notification indicating one or more RAN protocol stack capabilities of the second unit for use over the first interface to the first unit;
determine a RAN protocol stack to use for the first interface according to the one or more RAN protocol stack capabilities of the first unit and the one or more RAN protocol stack capabilities of the second unit; and
configure the first interface with the second unit according to the determined RAN protocol stack.

25-67. (canceled)
